(19) United States
(12) Patent Application Publication
(10) Pub. No.: US 2015/0128186 A1
(43) Pub. Date: May 7, 2015

(54) Mobile Multimedia Terminal, Video Program Recommendation Method and Server Thereof

(71) Applicant: NTT DoCoMo, Inc., Tokyo (JP)

(72) Inventors: Yingjie WANG, Beijing (CN); Yongsheng ZHANG, Beijing (CN); Hidetoshi KAYAMA, Beijing (CN)

(73) Assignee: NTT DoCoMo, Inc., Tokyo (JP)

(21) Appl. No.: 14/515,651

(22) Filed: Oct. 16, 2014

(30) Foreign Application Priority Data
Nov. 6, 2013 (CN) 201310545044.8

(51) Int. Cl. H04N 21/482; H04N 21/61; H04N 21/466

(52) U.S. Cl. CPC H04N 21/4826; H04N 21/4668; H04N 21/4828; H04N 21/6175
USPC 725/46

(57) ABSTRACT

The mobile multimedia terminal, a video program recommendation method and a server thereof may include steps of: extracting key information from electronic program guides; crawling social media information related with a terminal user from social media; generating an inquiry at least based on the key information and the crawled social media information; sending the inquiry to a server; searching for video programs in a broadcasting video library and an Internet video library by using the inquiry and taking information of public social media as a constraint condition, as video program recommendations for the terminal, by the server; sending the video program recommendations to the terminal by the server; and presenting the video program recommendations to the user in association with the played programs.

### CROSS-REFERENCE TO RELATED APPLICATION

The present application claims a priority of the Chinese patent application No. 201310545044.8 filed in China on Nov. 6, 2013, which is incorporated herein by reference in its entirety.

### TECHNICAL FIELD

The present disclosure relates to mobile video technology, and in particular, to a mobile multimedia terminal, a video program recommendation method and a server thereof.

### BACKGROUND

With the development of Internet technology and communication technology, Mobile Internet and Multimedia Broadcast have been widely applied in various aspects of daily life. A mobile multimedia broadcasting network may be standardized wireless broadcasting network systems, such as China Mobile Multimedia Broadcast (CMMB), Integrated Services Digital Broadcasting-Terrestrial mobile multimedia (ISTB-Tmm), etc. People receive multimedia broadcasts such as television and radio station programs through dedicated CMMB receiving terminals or mobile phones each provided with a CMMB module.

In this case, a mobile multimedia terminal can not only receive traditional television broadcasting programs, but also play streaming video programs on Internet by accessing the Internet, For example, a smart mobile phone or a tablet personal computer (PC) equipped with a CMMB module accesses Internet via WiFi or a wireless wide area network to achieve access to videos on the Internet. However, the massive video information on the Internet makes it difficult for a user to determine videos that he/she wants to watch. Generally, a user searches for desired video programs or preferred programs by searching for key words. How to voluntarily recommend related video programs to a user automatically according to the characteristic of the user is a technical problem in the mobile Internet age.

### SUMMARY

In view of one or more problems in the prior art, the present disclosure proposed a mobile Internet terminal, a video program recommendation method and a server thereof.

According to an aspect of the present disclosure, a method for providing video program recommendations to a mobile multimedia terminal is proposed, the method comprising the following steps of: extracting key information from electronic program guides (EPGs) of video programs and played video programs during a process of playing video programs on the mobile multimedia terminal; crawling social media information related with a user of the mobile multimedia terminal from social media; generating an inquiry request at least based on the key information and the crawled social media information; sending the inquiry request to a server; searching for video programs in a broadcasting video library and an Internet video library by using the inquiry request and taking information of public social media as a constraint condition, as video program recommendations for the mobile multimedia terminal by the server; sending the video program recommendations to the mobile multimedia terminal by the server; and presenting the video program recommendations to the user in association with the played programs.

According to another aspect of the present disclosure, a method for generating an inquiry request is proposed, the method comprising the following steps of: extracting key information from electronic program guides (EPGs) of video programs and played video programs during a process of playing video programs on a mobile multimedia terminal; crawling social media information related with a user of the mobile multimedia terminal from social media; generating an inquiry request based on the key information and the crawled social media information; sending the inquiry request to a server that generates video program recommendations based on the inquiry request; receiving the video program recommendations from the server; and presenting the video program recommendations to the user in association with the played programs.

According to still another aspect of the present disclosure, a mobile multimedia terminal for generating an inquiry request is proposed, the mobile multimedia terminal comprising: a key information extractor configured to extract key information from electronic program guides (EPGs) of video programs and played video programs during a process of playing video programs on the mobile multimedia terminal; a crawler configured to crawl social media information related with a user of the mobile multimedia terminal from social media; an inquiry request generator configured to generate an inquiry request based on the key information and the crawled social media information; a transceiver configured to send the inquiry request to a server that generates video program recommendations based on the inquiry request, and receive the video program recommendations from the server; and a player configured to present the video program recommendations to the user in association with the played programs.

According to still another aspect of the present disclosure, a server for providing video program recommendations is proposed, the server comprising: a transceiver configured to receive, from a mobile multimedia terminal, an inquiry request generated based on program information of video program being currently played on the mobile multimedia terminal and social media information related with a user of the mobile multimedia terminal; and a search engine configured to search for video programs in a broadcasting video library and an Internet video library by using the inquiry request and taking information of public social media as a constraint condition, as video program recommendations for the mobile multimedia terminal; wherein the transceiver further sends information of recommended video programs to the mobile multimedia terminal, thereby presenting the video program recommendations on the mobile multimedia terminal in association with the played programs.

By using the devices and methods disclosed in the above embodiments, an inquiry request is generated by using the played programs and the social media information of a user during the playing process, and is sent to a server. The server searches for a streaming media library by using the inquiry request and taking public social media information as a constraint to generate personalized and real-time video program recommendations.

### DESCRIPTION OF THE DRAWINGS

FIG. 1 illustrates the structure of a video program recommendation system according to an embodiment of the present disclosure;

FIG. 2 illustrates the structures of a mobile Internet terminal and a server in a video program recommendation system according to another embodiment of the present disclosure;

FIG. 3 illustrates a process of interaction between a mobile Internet terminal and a server according to an embodiment of the present disclosure; and

FIG. 4 is a flowchart of a recommendation method according to an embodiment of the present disclosure.

### DETAILED EMBODIMENTS

Preferred embodiments disclosed in the present disclosure will be described in detail hereinafter with reference to the accompanying drawings. Although shown in different drawings, the same reference sign is used to indicate the same or similar component. For clarity and simplicity, detailed description for known functions and structures included herein will be omitted to avoid unclearness of the subjects of respective embodiments of the present disclosure.

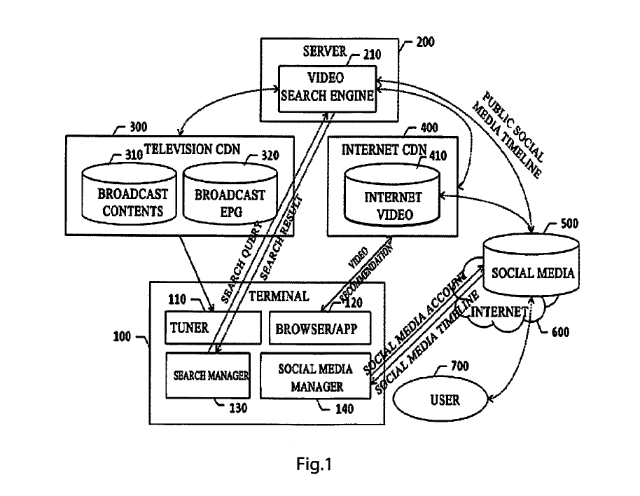

FIG. 1 is a schematic diagram of a video program recommendation system according to an embodiment of the present disclosure. According to one or more embodiments of the present disclosure, a terminal 100 is a smart mobile phone having a mobile television module, and thus can not only receive broadcasting and television programs, but also access video programs on the Internet 600, such as YouTube, etc., and social media 500, via for example WiFi or a wireless wide area network. For example, a user obtains traditional broadcasting programs through a tuner 110 in the terminal 100, and plays video programs on the Internet through a browser/APP 120.

In the embodiments shown in the figures, key information is extracted from an EPG of a video program being played and a played video program during a process of playing the video program on a mobile multimedia terminal 100; social media information related with a user 700 of the mobile multimedia terminal 100 from social media. Then, an inquiry request is generated at least based on the key information and the crawled social media information, and the inquiry request is sent to a server 200. For example, in some embodiments, a terminal 110 further includes a search manager 130 and a social media manager 140. The social media manager 140 manages a user's social media IDs such as Twitter or Weibo, and some information (e.g., social media timeline) of members of the social circle of the user 700. The search manager 130 generates a search query by using the user's social media information and/or search history information, and meanwhile based on information in electronic program guides (EPGs) of broadcasting programs and/or information in key frames of the broadcasting programs. The search query is sent to the server 200 via a wireless link to seek for video recommendations for the video programs being currently played.

In the embodiments as shown in figures, the search engine 210 of the server 200 searches for video programs in a broadcasting video library 300 and an Internet video library 400 by using the inquiry request and taking information of public social media as a constraint condition, as video program recommendations for the mobile multimedia terminal 100. Then, the server 200 sends the video program recommendations to the mobile multimedia terminal 100. The video program recommendations are presented to the user 700 in association with the played programs at the mobile terminal 100. For example, the server 200 has a video search engine 210, which crawls related key words from a public social media 500 after receiving a search query from the terminal 210, and then generates social media indices, meanwhile crawls related key words from broadcast contents 310 and broadcast EPG 320 of Internet video 410 of Internet CDN 400 and/or television CDN 300 to generate streaming video indices. Then, the server 200 searches for video programs in streaming indices and social media indices by using the search query, as video recommendations. In other embodiments, the search engine 210 may also crawls public social media beforehand to generate public social media indices, crawls video libraries 300 and 400 to generate streaming video indices, and searches for video recommendations in the obtained indices after receiving the search query. Then, the server 200 sends the video recommendations obtained by the search engine to the terminal 100, and after the user clicks the video recommendations, for example, a certain program in the Internet video library, a browser/APP 120 downloads from the Internet video library 400 and plays the recommended video programs.

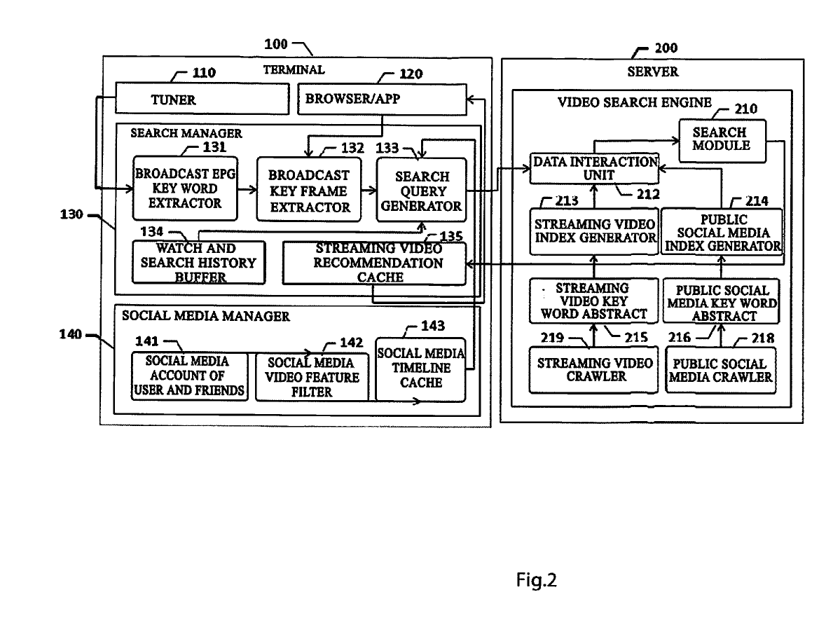

FIG. 2 illustrates the structures of a mobile Internet terminal and a server in a video program recommendation system according to another embodiment of the present disclosure. The system shown in FIG. 2 includes a terminal 100 and a server 200. The terminal 100 includes a tuner 100, a browser/APP 120, a search manager 130 and a social media manager 140. In the embodiments shown in the figures, the search manager 130 specifically includes a broadcast EPG key word extractor 131, a broadcast key frame extractor 132, a watch and search history cache 134, a streaming media recommendation cache 135 and a search query generator 133. The social media manager 140 manages social media IDs 141 of a user and his/her friends, and filters video links on the social media by using a social video feature filter, and stores the obtained social media timeline in a social media timeline cache 143.

As shown in FIG. 2, the broadcast EPG key word extractor 131 parses the electronic program guides in the video programs being played to extract key words. The broadcast key frame extractor 132 extracts key frames from the video programs, for example, extracting image frames representative of the main contents of the video shots in the video programs as the key frames. The broadcast key frame extractor 132 recognizes the extracted key frames to obtain recognized text contents, and combines at least part of the recognized text contents and the key words, uses the combined as the key information. For example, the broadcast key frame extractor 132 recognizes text contents in the extracted key frames by using text recognization technology and/or weights at least part of the recognized text contents and the key words followed by sequencing them to generate the key information. In this way, the search query generator 133 generates an inquiry request at least based on the key information and the crawled social media information. In other embodiments, the search query generator 133 further generates an inquiry request based on the above key information and the crawled social media information in addition to information in the user's watch and search history cache 134, and such an inquiry request takes comprehensive consideration of several kinds of information closely related with the user, and thus can reflect a user's requirement more accurately.

Then, the terminal 100 sends the inquiry request to the server 200 through a transceiver (not shown). Thereafter, the search engine 210 searches for video programs in a broadcasting video library 300 and/or an Internet video library 400 by using the inquiry request and taking information of a public social medium as a constraint condition, as video program recommendations for the mobile multimedia terminal 100. The search engine 210 shown in FIG. 2 includes a search module 211, a data interaction unit 212, a streaming video index generator 213, a public social media index generator 214, a streaming video key word abstract 215, a public social media key word abstract 216, a streaming video crawler 217 and a public social media crawler 218.

In some embodiments, a streaming video crawler 217 crawls key words of a streaming video in a broadcasting video library 300 and/or Internet video library 400 to generate a streaming video key word abstract 215, and then a streaming video index generator 213 generates streaming video indices by scoring these key word abstracts. Meanwhile, a public social media crawler 218 crawls key words from public social media to generate a public social media key word abstract 216, and thereby a public social media index generator 214 generates public social media indices by scoring the public social media abstracts. The search module 211 obtains search results by matching with streaming video indices and public social media indices in the data interaction unit 212 by using a search query from the terminal 100, for example, several indices that most match with the search query are taken as search results to generate video recommendations. Then, the server 200 sends the video program recommendations to the mobile multimedia terminal 100 to be stored in a streaming media recommendation cache 135. Next, the browser/APP 120 presents the video program recommendations to the user in association with the played programs.

According to some embodiments, during the process of presenting the video program recommendations to the user in association with the played programs, the genres of the video programs are detected to determine to present the video program recommendations to the user before, during or after playing the video programs. In addition, in response to a selection of the user for the video program recommendations, a preview of the video recommendations is played without affecting the currently played video programs. In other embodiments, in order to count the click through rates of the video program recommendations, the terminal 100 further counts the click through rates of the video program recommendations by the user as auxiliary rating information, and sends the auxiliary rating information to the server 200.

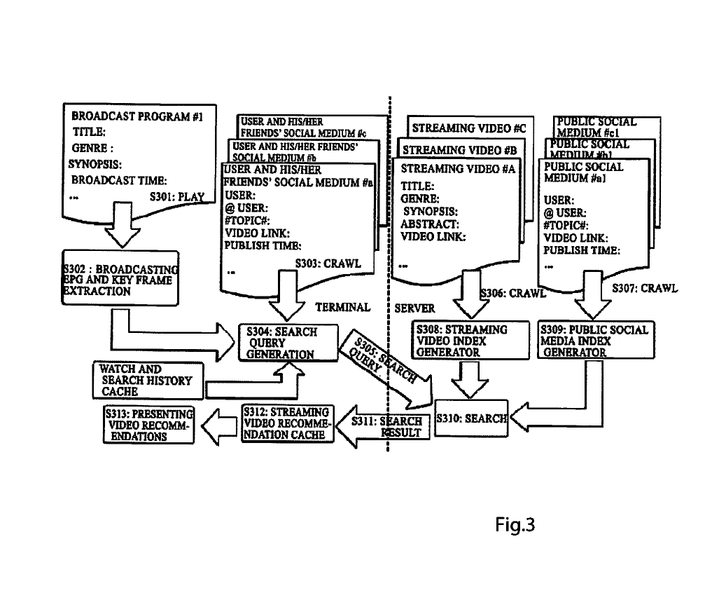

FIG. 3 shows a process of interaction between a mobile Internet terminal and a server according to an embodiment of the present disclosure.

As shown in FIG. 3, in step S301, a terminal 100 plays a mobile television program, for example a broadcasting program #1, through a tuner, and the broadcasting program has metadata such as title, genre, synopsis, broadcast time, etc.

In step S302, key information is extracted from the electronic program guides of the video programs and the played video programs during the method processing of playing the video programs on a mobile multimedia terminal 100.

In step S303, by using social media IDs of a user and his/her friends and their social media information, the social media manager of the mobile multimedia terminal 100 crawls public social media information related with these members. For example, each member has his/her own metadata such as ID, related subject, video link and publish time, etc.

In step S304, the search query generator 133 generates an inquiry request at least based on the key information and crawled social media information. In other embodiments, an inquiry request may also be generated further based on history information in the watch and search history cache.

In step S305, the mobile terminal 100 sends the generated inquiry request to the server 200. The crawler of the search engine crawls a broadcasting video library 300 and an Internet video library 400 in step S306, and generates streaming video indices in step S308. The crawler of the search engine may also crawl public social media in step S307, and generates public social media indices in step S309. Then, in step S310, the server 200 searches for video programs in a broadcasting video library 300 and an Internet video library 400 by using the inquiry request and taking information of a public social medium as a constraint condition, as video program recommendations for the mobile multimedia terminal.

In step S311, the server 200 sends the generated video recommendations to the mobile terminal 100. In step S312, the video recommendations are stored in a streaming media recommendation cache 135. Next, in step S313, the browser/APP 120 presents the video program recommendations to the user in association with the played programs.

Although some of the embodiments of the present disclosure are described in the above embodiments in connection with the process of interaction between a terminal 100 and a server, a person having ordinary skill in the art may implement the present disclosure at the mobile terminal 100 or the server 200, for example, an inquiry request is generated at the mobile terminal 100 and the programs are presented based on the video recommendations from the server. On the other hand, at the server 200, an inquiry request is received from the terminal for search to obtain video recommendations.

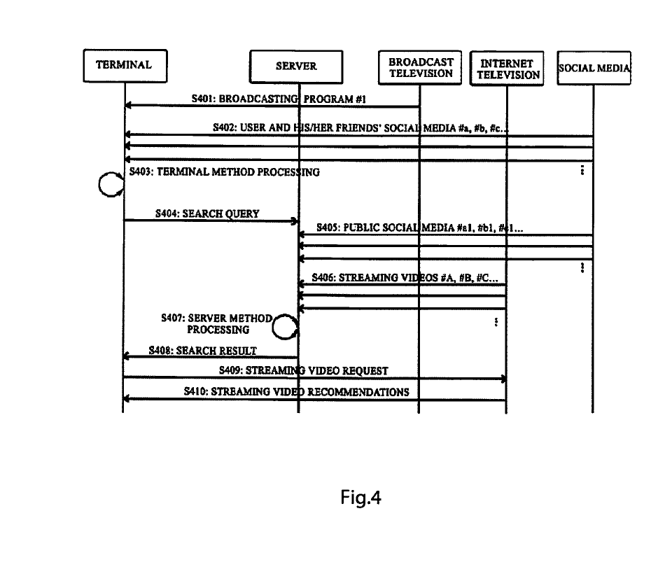

FIG. 4 is a flowchart of a recommendation method according to an embodiment of the present disclosure. As shown in FIG. 4, a terminal 100 plays a mobile television program for example a broadcasting program #1, through a tuner, and the broadcasting program has metadata such as title, genre, synopsis, broadcast time, etc. In step S402, by using social media IDs of a user and his/her friends and their social media information, the social media manager of the mobile multimedia terminal 100 crawls public social media information related with these members. For example, each member has his/her own metadata such as account, related topic, video link and publish time, etc. Then, the mobile terminal generates a search query by using the above information in step S403, and sends the generated search query to the server 200 in step S404.

The crawler of the search engine crawls a broadcasting video library 300 and an Internet video library 400 in step S405, and generates streaming video indices. The crawler of the search engine 210 may also crawl public social media in step S406, and generate public social media indices. Then, in step S407, the server 200 searches for video programs in a broadcasting video library 300 and an Internet video library 400 by using the inquiry request and taking information of a public social medium as a constraint condition, as video program recommendations for the mobile multimedia terminal.

In step S408, the server 200 sends the generated video recommendations to the mobile terminal 100, for example, the video recommendations are stored in a streaming media recommendation cache. Next, in step S409, when a user selects the provided video recommendations, the browser/APP 120 downloads from, for example, the Internet video library and plays the video programs in step S410.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Although the present disclosure is described with reference to several typical embodiments, it should be appreciated that the terms used are descriptive and illustrative, rather than limiting terms. Since the present disclosure can be specifically implemented in many forms without departing the spirit or essence of the invention, it shall be appreciated that the above embodiments are not limited to any aforesaid detail, but should be widely construed in the spirit and scope defined in the attached claims. Therefore, all changes and transformations falling into the scope of the claims or equivalent scope thereof shall be covered by the attached claims.

What is claimed is:

1. A method for providing video program recommendations to a mobile multimedia terminal, comprising the following steps of:
extracting key information from electronic program guides (EPGs) of video programs and played video programs during a process of playing video programs on the mobile multimedia terminal;
crawling social media information related with a user of the mobile multimedia terminal from social media;
generating an inquiry request at least based on the key information and the crawled social media information;
sending the inquiry request to a server;
searching for video programs in a broadcasting video library and an Internet video library by using the inquiry request and taking information of public social media as a constraint condition, as video program recommendations for the mobile multimedia terminal, by the server;
sending the video program recommendations to the mobile multimedia terminal by the server; and
presenting the video program recommendations to the user in association with the played programs.

2. The method according to claim 1, wherein the step of extracting key information from electronic program guides (EPGs) of video programs and played video programs comprises:
parsing the electronic program guides to extract key words;
extracting key frames from the video programs;
recognizing the extracted key frames to obtain recognized text contents; and
combining at least part of the recognized text contents and the key words, using the combined as the key information.

3. The method according to claim 2, wherein the step of extracting key frames from the video programs comprises:
extracting image frames representative of main contents of video shots from the video programs as the key frames.

4. The method according to claim 2, wherein the step of recognizing the extracted key frames comprises:
recognizing text contents in the extracted key frames by using text recognization technology.

5. The method according to claim 2, wherein the step of combining at least part of the recognized text contents and the key words, using the combined as the key information comprises:
weighting at least part of the recognized text contents and the key words followed by sequencing them to generate the key information.

6. The method according to claim 1, wherein the step of searching for video programs in a broadcasting video library and an Internet video library by using the inquiry request and taking information of public social media as a constraint condition by the server comprises:
crawling contents on the public social media to generate public social media indices;
crawling the broadcasting video library and Internet video library to generate streaming video indices;
matching the search query with the public social media indices and the streaming video indices; and
taking contents corresponding to the public social media indices or the streaming video indices whose matching degree is higher than a predetermined threshold as the search results.

7. The method according to claim 1, wherein the step of crawling social media information related with a user of the mobile multimedia terminal from social media comprises:
obtaining related social media information from the social media by using social media identities (IDs) of a user and his/her friends.

8. The method according to claim 1, wherein the step of generating the inquiry request at least based on the key information and the crawled social media information comprises:
generating the search query according to the user's watch and search history information, the key information and crawled social media information.

9. The method according to claim 1, wherein the step of presenting the video program recommendations to the user in association with the played video programs comprises:
detecting genres of the played video programs to determine to present the video program recommendations to the user before, during or after playing the video programs.

10. The method according to claim 9, wherein the step of presenting the video program recommendations to the user in association with the played programs further comprises:
in response to a selection of the user for the video program recommendations, playing a preview of the video program recommendations without affecting currently played video programs.

11. The method according to claim 1, further comprising:
counting click through rates of the video program recommendations by the user as auxiliary rating information; and
sending the auxiliary rating information to the server.

12. A method for generating an inquiry request, comprising the following steps of:
extracting key information from electronic program guides (EPGs) of video programs and played video programs during a process of playing video programs on a mobile multimedia terminal;
crawling social media information related with a user of the mobile multimedia terminal from social media;
generating an inquiry request based on the key information and the crawled social media information;
sending the inquiry request to a server that generates video program recommendations based on the inquiry request;
receiving the video program recommendations from the server; and
presenting the video program recommendations to the user in association with the played programs.

13. A method for providing video program recommendations, comprising the following steps of:
receiving, from a mobile multimedia terminal, an inquiry request generated based on program information of video programs being currently played on the mobile multimedia terminal and social media information related with a user of the mobile multimedia terminal;
searching for video programs in a broadcasting video library and an Internet video library by using the inquiry request and taking information of public social media as a constraint condition, as video program recommendations for the mobile multimedia terminal; and
sending information of recommended video programs to the mobile multimedia terminal, thereby presenting the video program recommendations on the mobile multimedia terminal in association with the played programs.

14. A mobile multimedia terminal for generating an inquiry request, comprising:
a key information extractor configured to extract key information from electronic program guides (EPGs) of video programs and played video programs during a process of playing video programs on the mobile multimedia terminal;
a crawler configured to crawl social media information related with a user of the mobile multimedia terminal from social media;
an inquiry request generator configured to generate an inquiry request based on the key information and the crawled social media information;
a transceiver configured to send the inquiry request to a server that generates video program recommendations based on the inquiry request, and receive the video program recommendations from the server; and
a player configured to present the video program recommendations to the user in association with the played programs.

15. A server for providing video program recommendations, comprising:
a transceiver configured to receive, from a mobile multimedia terminal, an inquiry request generated based on program information of video programs being currently played on the mobile multimedia terminal and social media information related with a user of the mobile multimedia terminal; and
a search engine configured to search for video programs in a broadcasting video library and an Internet video library by using the inquiry request and taking information of public social media as a constraint condition, as video program recommendations for the mobile multimedia terminal;
wherein the transceiver further sends information of recommended video programs to the mobile multimedia terminal, thereby presenting the video program recommendations on the mobile multimedia terminal in association with the played programs.
